(19) United States
(12) Patent Application Publication
(10) Pub. No.: US 2025/0277678 A1
(43) Pub. Date: Sep. 4, 2025

(54) ROTARY SENSOR DEVICE, ROTARY SENSOR UNIT, AND INSTALLATION METHOD FOR ROTARY SENSOR DEVICE

(71) Applicant: TDK Corporation, Tokyo (JP)

(72) Inventors: Teiichiro OKA, Tokyo (JP); Ryoichi MENJU, Tokyo (JP); Hiroyuki HIRANO, Tokyo (JP); Makoto TAKAHASHI, Tokyo (JP)

(73) Assignee: TDK Corporation, Tokyo (JP)

(21) Appl. No.: 19/066,673

(22) Filed: Feb. 28, 2025

(30) Foreign Application Priority Data
Mar. 1, 2024 (JP) 2024-031421
Mar. 1, 2024 (JP) 2024-031441

(51) Int. Cl. G01D 5/14

(52) U.S. Cl. CPC G01D 5/14

(57) ABSTRACT

A rotary sensor device detects a rotational state, such as the rotation angle, of a magnetic field generation unit that rotates about a rotational axis. The magnetic field generation unit has at least a partial cylindrical surface, which is a part or all of a cylindrical surface that generates a magnetic field symmetrical with respect to the rotational axis and is located at a first distance from the rotational axis. The rotary sensor device includes a functional film containing a magnetic detection element that detects the magnetic field generated by the magnetic field generation unit, and a guide portion provided at a second distance from a normal passing through a center of the functional film. The second distance is the same as or slightly larger than the first distance, and the guide portion is arranged to face the cylindrical surface.

### CROSS-REFERENCE TO RELATED APPLICATIONS

This application claims the benefit of Japanese Priority Patent Applications No. 2024-031441 filed on Mar. 1, 2024 and No. 2024-031421 filed on Mar. 1, 2024, the entire contents of each are incorporated herein by reference.

### FIELD

The present disclosure relates to a rotary sensor device, a rotary sensor unit, and an installation method for a rotary sensor device.

### BACKGROUND

As rotary sensor devices that measure rotational states such as a rotation angle, a rotational speed, or a rotational frequency at the end of the rotating body, magnetic types, optical types, electromagnetic induction types, and the like have been known. Optical rotary sensor devices measure a rotation angle using a slit that protrudes radially from the output shaft (see, for example, U.S. Patent Specification No. 6563108). Similarly, electromagnetic induction rotary sensor devices measure a rotation angle using a coil that protrudes radially from the output shaft. In such devices, the slit or coil becomes larger in size as measurement resolution or measurement accuracy is increased, making it difficult to downsize the devices. As opposed to this, magnetic rotary sensor devices measure a rotation angle using a magnet attached along the extension line in the axial direction of the output shaft. Therefore, the magnetic rotary sensor devices are capable of achieving downsizing or reducing manufacturing costs, compared to rotary sensor devices based on different principles.

### SUMMARY

However, the magnetic rotary sensor devices cause measurement errors if the detection point of a magnetic sensor chip is shifted from the rotational center of the output shaft. Although it is possible to align the rotary sensor devices with a housing by placing a mark on the housing of an electric motor or the like, there remains a shift in the assembly accuracy between the rotating body and the rotary sensor devices. It is preferable to directly align the rotating body with the rotary sensor devices. It is also possible to install the rotary sensor devices and adjust their position while confirming an electronic signal. However, this makes the assembly procedure complicated, placing greater burden on the operator.

The present disclosure has been made in view of the above circumstances and has an object of providing a technology capable of aligning the center of a detection unit, which includes a magnetic detection element, with a rotational axis in a magnetic rotary sensor device.

A rotary sensor device according to an example embodiment of the present disclosure is a rotary sensor device that detects a rotational state of a magnetic field generation unit that rotates about a rotational axis. The magnetic field generation unit has at least a partial cylindrical surface, which is a part or all of a cylindrical surface that generates a magnetic field symmetrical with respect to the rotational axis and is located at a first distance from the rotational axis. The rotary sensor device includes a functional film containing a magnetic detection element that detects the magnetic field generated by the magnetic field generation unit, and a guide portion provided at a second distance from a normal passing through a center of the functional film. The second distance is same as or slightly larger than the first distance, and the guide portion is arranged to face at least the partial cylindrical surface.

A rotary sensor device according to another example embodiment of the present disclosure is a rotary sensor device that detects a rotational state of a magnetic field generation unit that rotates about a rotational axis. The magnetic field generation unit has a cylindrical surface that generates a magnetic field symmetrical with respect to the rotational axis and is centered about the rotational axis. The rotary sensor device includes a magnetic detection element that detects the magnetic field generated by the magnetic field generation unit and a guide member that is deformable into a first shape in contact with the cylindrical surface and a second shape separated from the cylindrical surface.

According to the present disclosure, it is possible to provide a technology capable of aligning the center of a functional film, which represents a detection unit including a magnetic detection element, with a rotational axis in a magnetic rotary sensor device.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is an exploded perspective view of a rotary sensor unit according to an example embodiment of the present disclosure;

FIG. 2 is a perspective view showing a rotary sensor device that is installed onto the housing of an electric motor;

FIG. 3 is a perspective view showing a magnetic field generation unit that is attached to the output shaft of the electric motor;

FIG. 4 is a block diagram showing an example of a rotating mechanism that includes the electric motor shown in FIG. 2;

FIGS. 5A to 5C are diagrams each schematically showing an example of the magnetic field generation unit shown in FIG. 1;

FIG. 6 is a bottom view showing the rotary sensor unit shown in FIG. 1;

FIG. 7 is a bottom view showing a rotary sensor device shown in FIG. 6;

FIG. 8 is a cross-sectional view of the rotary sensor unit shown in FIG. 6;

FIG. 9 is a bottom view schematically showing a functional film shown in FIG. 8;

FIG. 10 is a flowchart for describing an installation method for the rotary sensor device;

FIG. 11 is a perspective view showing guide portions according to a first embodiment;

FIG. 12 is a perspective view showing the guide portions according to a second embodiment;

FIG. 13 is a bottom view schematically showing the guide portions according to a third embodiment;

FIG. 14 is a bottom view schematically showing the magnetic field generation unit according to a fourth embodiment;

FIG. 15 is a bottom view showing the guide portions according to a fifth embodiment;

FIG. 16 is a bottom view showing a first shape of a guide member according to a sixth embodiment;

FIG. 17 is a bottom view showing the rotary sensor device shown in FIG. 16;

FIG. 18 is a bottom view showing a second shape of the guide member according to the sixth embodiment;

FIG. 19 is a flowchart for describing an installation method for the rotary sensor device;

FIG. 20 is a bottom view showing the first shape of the guide member according to a seventh embodiment;

FIG. 21 is a bottom view showing the second shape of the guide member according to the seventh embodiment;

FIG. 22 is a planar view showing the first shape of the guide member according to the eighth embodiment;

FIG. 23 is a planar view showing the second shape of the guide member according to the eighth embodiment; and

FIG. 24 is a side view showing the first shape of the guide member according to a ninth embodiment.

### DETAILED DESCRIPTION

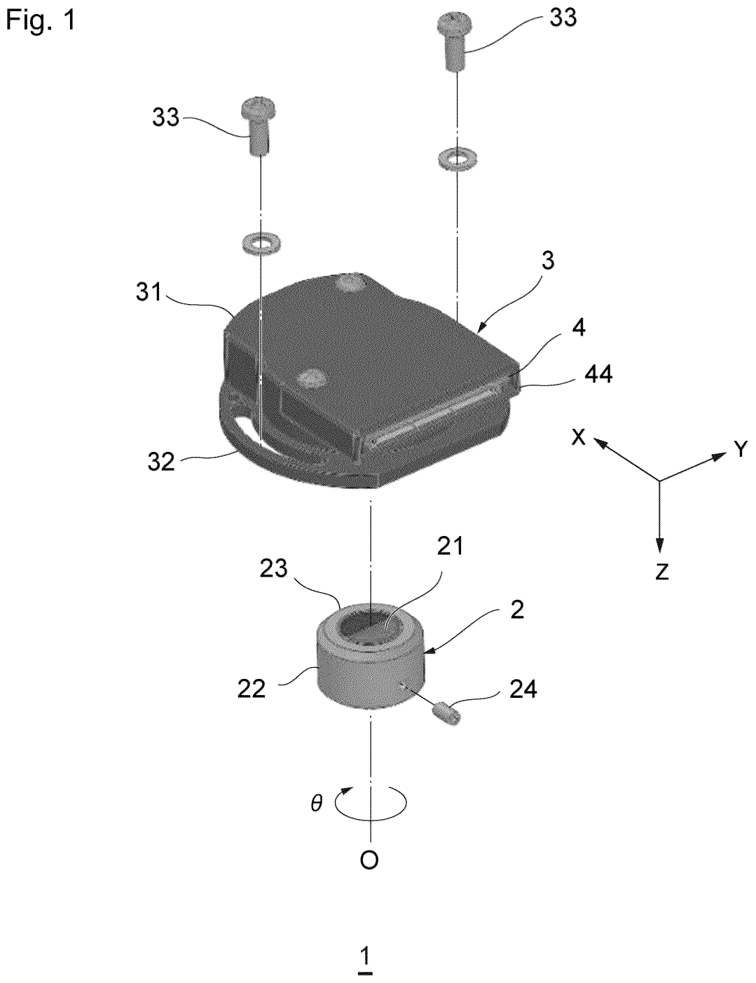

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions. Note that in each drawing, elements denoted by the same reference numerals have the same or similar configurations. Hereinafter, each configuration will be described in detail with reference to FIGS. 1 to 24.

FIG. 1 is an exploded perspective view of a rotary sensor unit 1 according to an example embodiment of the present disclosure. As shown in FIG. 1, the rotary sensor unit 1 includes a magnetic field generation unit 2, a rotary sensor device 3, and the like. The magnetic field generation unit 2 has at least a partial cylindrical surface 22, an end surface 23, and the like. As will be described later, the cylindrical surface 22 may be either a 360-degree circumferential surface or a part of a 360-degree circumferential surface. In the following description, “at least the partial cylindrical surface 22” may simply be referred to as the “cylindrical surface 22” as appropriate. The rotary sensor device 3 detects the rotational state, such as a rotation angle θ, of the magnetic field generation unit 2 that rotates about a rotational axis O. A housing 31 of the rotary sensor device 3 may be provided with a flange 32 that has a long hole formed for installation.

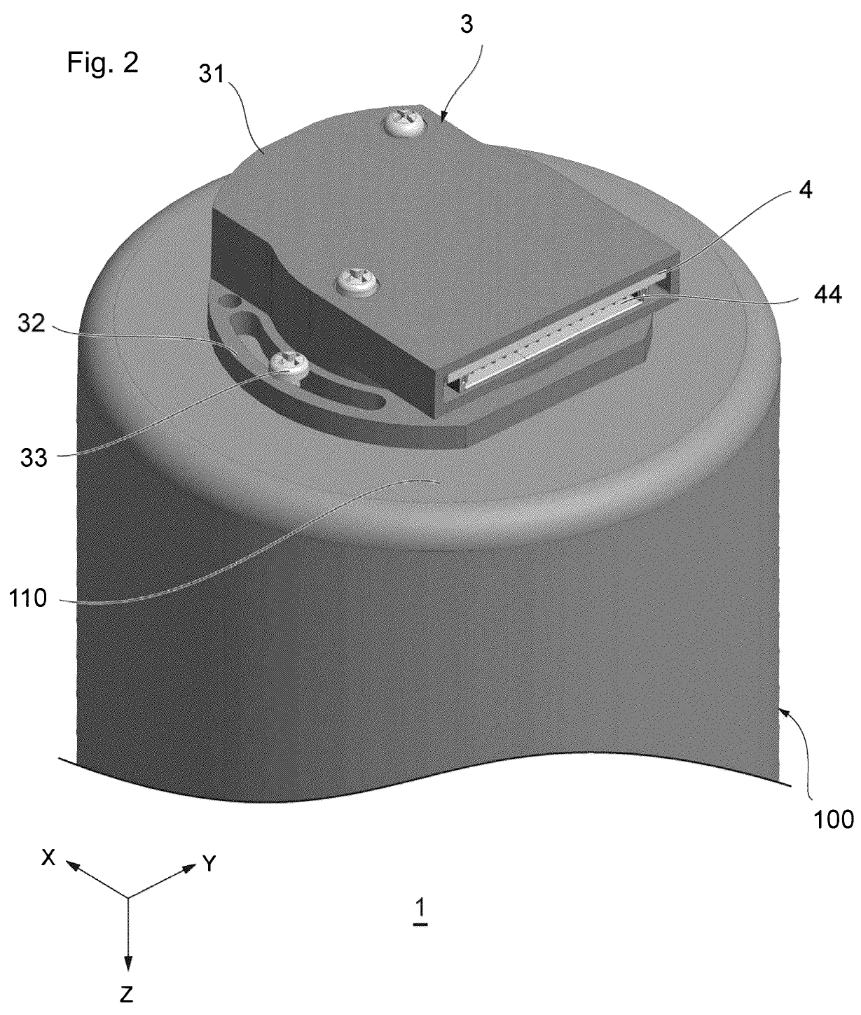

FIG. 2 is a perspective view showing the rotary sensor device 3 that is installed onto a housing (motor housing) 110 of an electric motor 100. As shown in FIG. 2, the rotary sensor device 3 may be fixed to the housing 110 by a fastening screw 33 that is inserted through the long hole of the flange 32.

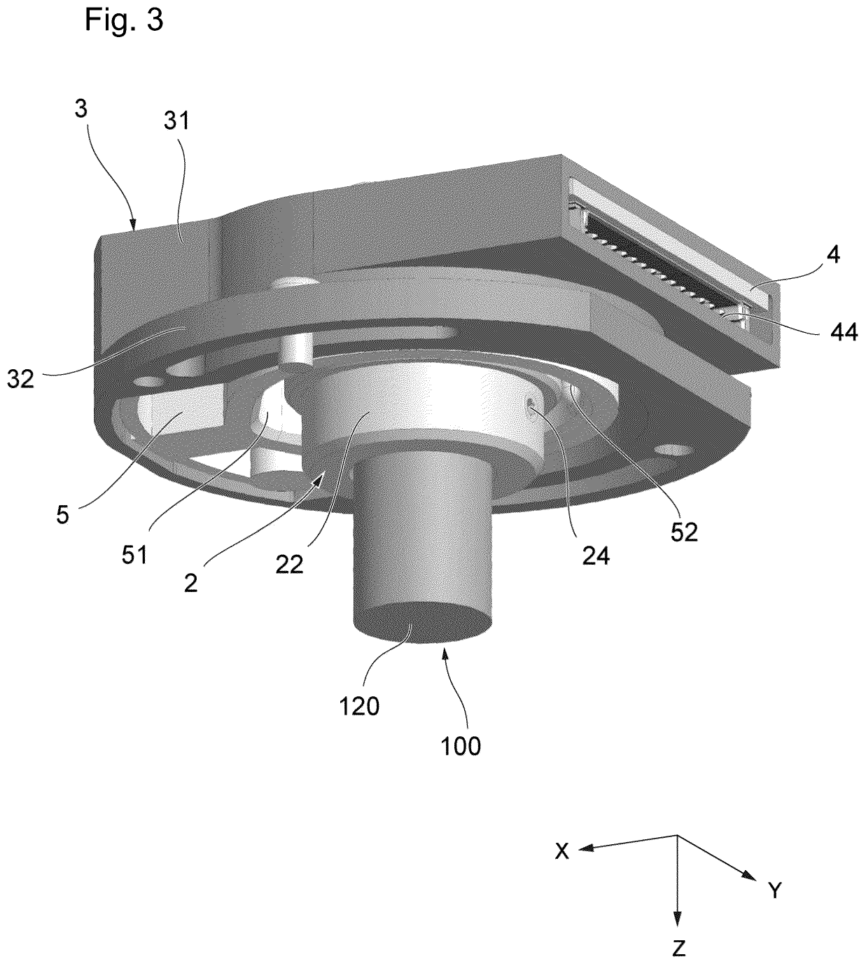

FIG. 3 is a perspective view showing the magnetic field generation unit 2 that is attached to an output shaft (motor shaft) 120 of the electric motor 100. The output shaft 120 of the electric motor 100 may be an example of a rotating body.

The housing 110 described above may be an example of a housing that rotatably supports a rotating body such as the output shaft 120.

As shown in the illustrated example, the magnetic field generation unit 2 may be configured to be separable from a rotating body, such as the output shaft 120. The magnetic field generation unit 2 is formed, for example, in a cylindrical shape and rotates together with the rotating body when it is fixed to the rotating body by an embedded screw 24 or the like. The configuration of the magnetic field generation unit 2 is not limited to the illustrated example, and the magnetic field generation unit 2 may be embedded in the rotating body to form an integral structure.

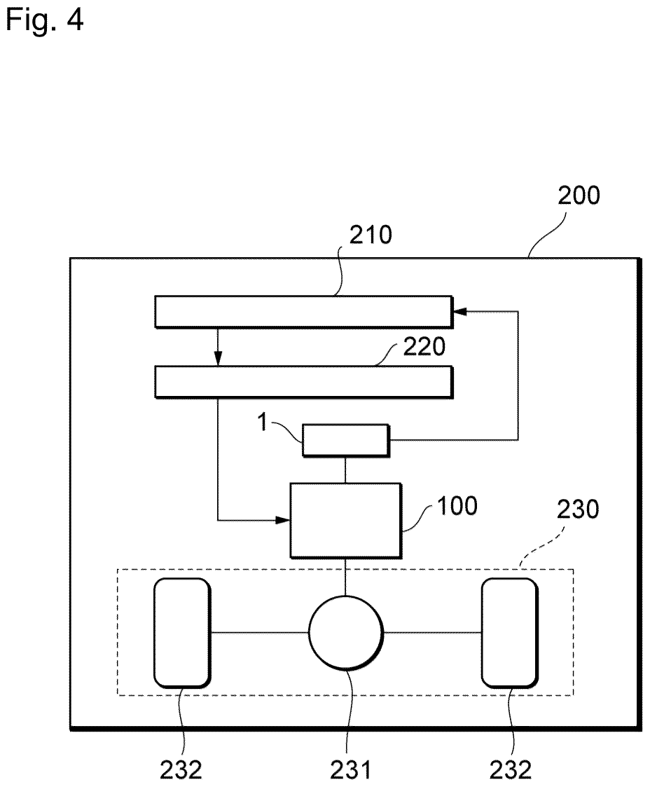

FIG. 4 is a block diagram showing an example of a rotating mechanism 200 that includes the electric motor 100 shown in FIG. 2. The rotating mechanism 200 may include a load 230, which is rotationally driven by the electric motor 100 that includes the rotary sensor unit 1. As shown in the illustrated example, the rotating mechanism 200 may be configured as an autonomous mobile robot that travels while automatically detouring around operators or obstacles and transports baggage.

The rotating mechanism 200 is not limited to an autonomous mobile robot and may also be a battery electric vehicle, a hybrid electric vehicle, an elevator, or an actuator.

The autonomous mobile robot may include wheels 232 for traveling, a transmission mechanism 231 that connects the output shaft 120 of the electric motor 100 and the wheels 232, and the like as the load 230 that is rotationally driven by the electric motor 100. The autonomous mobile robot may also include a power supply unit 220, such as a battery, that supplies power to the electric motor 100, a control unit 210 that controls the power supply unit 220, and the like. The control unit 210 may be configured to transmit a motor driving signal to the power supply unit 220 on the basis of a feedback signal that is received from the rotary sensor unit 1, in order to control the rotation of the electric motor 100.

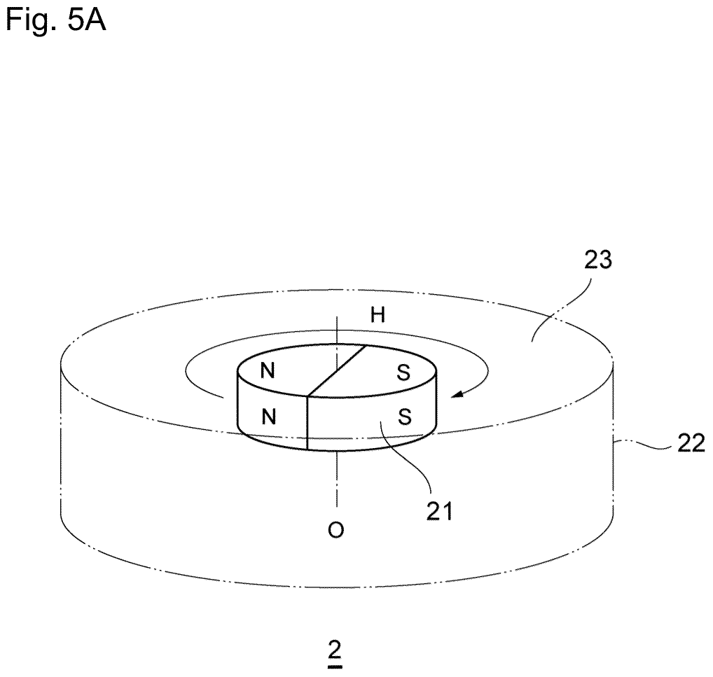

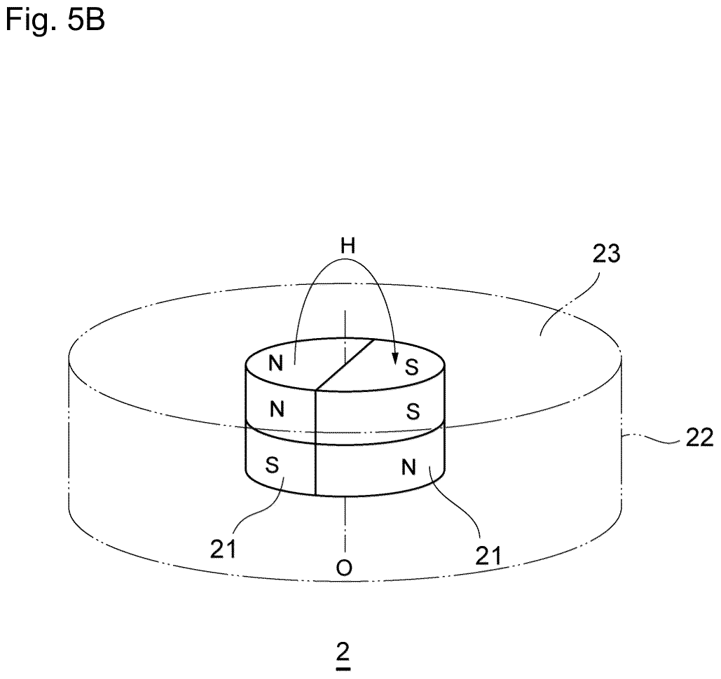

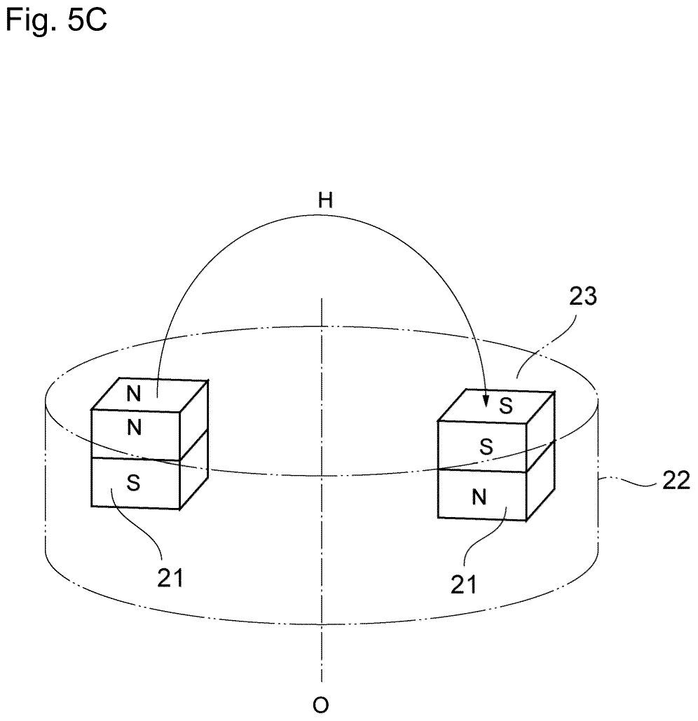

FIGS. 5A to 5C are diagrams each schematically showing an example of the magnetic field generation unit 2 shown in FIG. 1. The magnetic field generation unit 2 generates a magnetic field H that is symmetrical about the rotational axis O. As shown in the example of FIG. 5A, the magnetic field generation unit 2 may be magnetized in the direction orthogonal to the rotational axis O, and may include a magnet 21 that is arranged on the rotational axis O. As shown in the example of FIG. 5A, the N and S poles of the magnet 21 may be symmetrically positioned with respect to the rotational axis O. Without being limited to the illustrated example, the magnet 21 may be a rod magnet with its both ends magnetized to the N and S poles, rather than being disc-shaped.

As shown in the examples of FIGS. 5B and 5C, the magnetic field generation unit 2 may also include a pair of magnets 21 that is magnetized parallel to the rotational axis O and in opposite directions. The pair of magnets 21 may be arranged symmetrically about the rotational axis O. More specifically, as shown in the example of FIG. 5A, the pair of magnets 21 may be arranged in proximity to each other. As shown in the example of FIG. 5C, the pair of magnets 21 may be arranged to be spaced away from each other. As shown in the examples of FIGS. 5B and 5C, the N pole of one magnet 21 may be symmetrically positioned relative to the S pole of the other magnet 21 with respect to the rotational axis O. Similarly, the S pole of one magnet 21 may be symmetrically positioned relative to the N pole of other magnet 21 with respect to the rotational axis O. It is known that the magnetic field H is strengthened when a yoke is present on the bottom surface side.

When using a magnetic field generated from a multipole, it is more difficult to achieve high accuracy due to the influence of magnetization accuracy, compared to using a magnetic field generated from the two N and S poles. According to the examples shown in FIGS. 5A to 5C, it is possible to generate the magnetic field H from the two N and S poles.

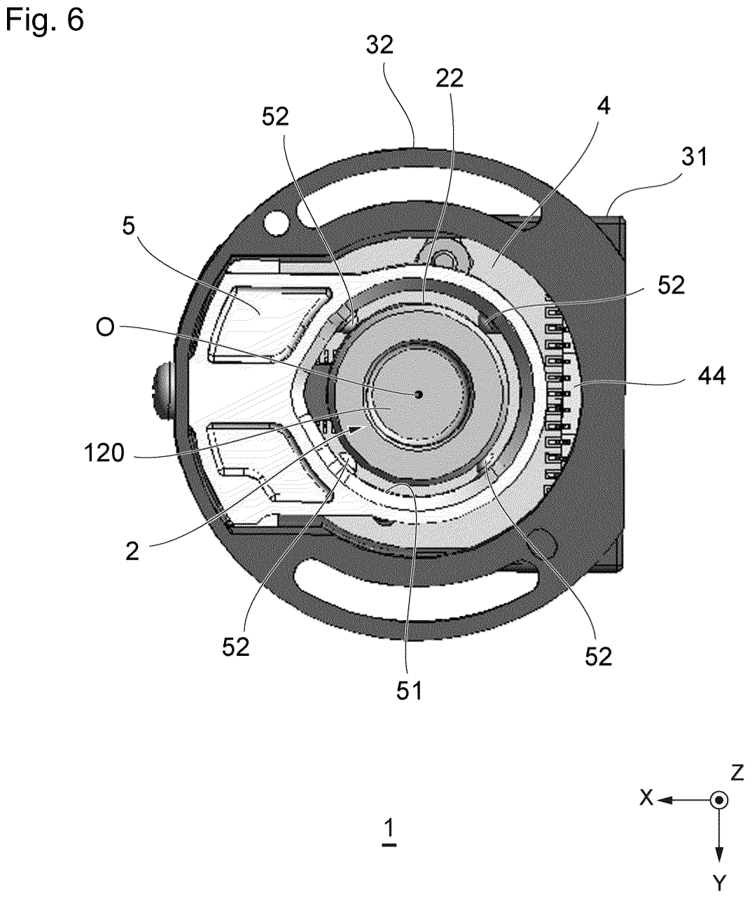

FIG. 6 is a bottom view showing the rotary sensor unit 1 shown in FIG. 1. As shown in FIG. 6, the rotary sensor device 3 may include a substrate 4, a guide member 5, and the like that are accommodated in the housing 31. The guide member 5 may have a cavity 51 formed to accommodate the magnetic field generation unit 2.

The guide member 5 may include at least one guide portion 52, and the number of the guide portions 52 may be three or more. As shown in the illustrated example, the four guide portions 52 may be formed. Note that the number of the guide portions 52 may be one. In this case, the shape of the guide portion 52 may be either a cylinder that conforms to the 360-degree circumferential cylindrical surface 22 or a recessed cylindrical surface that conforms to the partial cylindrical surface 22.

The material for the guide member 5 including the plurality of guide portions 52 may be engineering plastic, such as polyacetal resin, polyamide resin, or polybutylene terephthalate resin, which has excellent characteristics such as mechanical strength, wear resistance, and self-lubricity. Each of the plurality of guide portions 52 may be arranged to face the cylindrical surface 22 of the magnetic field generation unit 2. As shown in the illustrated example, at least a part of the plurality of guide portions 52 may be in contact with the cylindrical surface 22. Note that, as the rotary sensor unit 1 is used, the guide portion 52 may wear and no longer be in contact with the cylindrical surface 22.

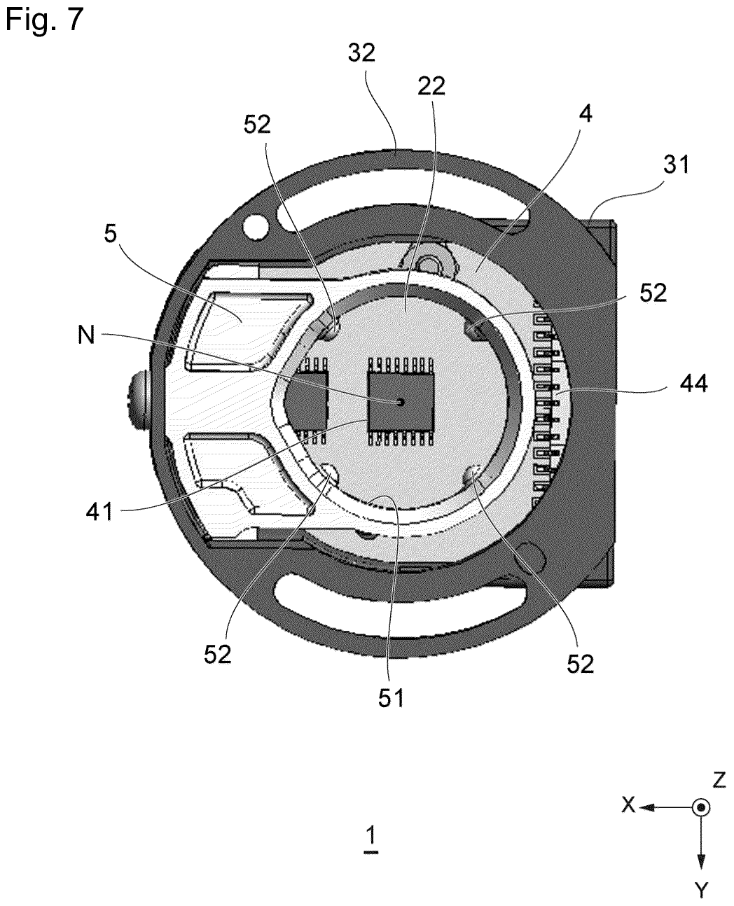

FIG. 7 is a bottom view showing the rotary sensor device 3 shown in FIG. 6. As shown in FIG. 7, a magnetic sensor chip 41 that detects the rotational state, such as a rotation angle θ, of the magnetic field generation unit 2, a connector 44 that is connected to a power supply or external equipment, and the like are mounted on the substrate 4. The substrate 4 may be either a rigid substrate or a flexible substrate.

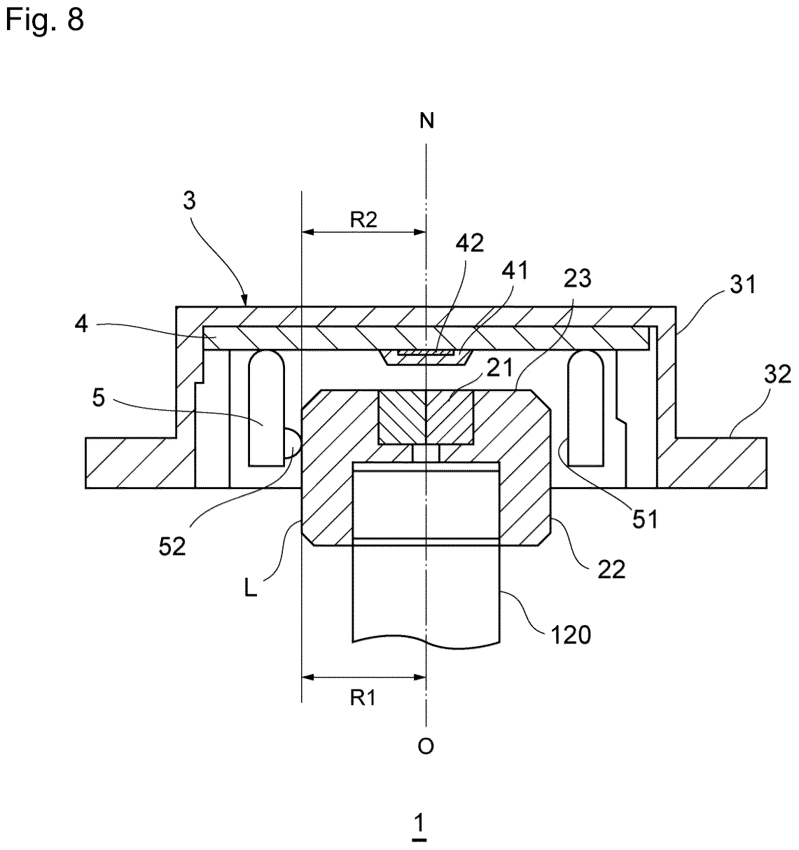

FIG. 8 is a cross-sectional view of the rotary sensor unit 1 shown in FIG. 6. As shown in FIG. 8, the magnetic sensor chip 41 may face the end surface 23 and include a functional film 42. The end surface 23 may be parallel to an XY plane, which will be described later. Each of the plurality of guide portions 52 may be provided at a second distance R2 from a normal N that passes through the center of the functional film 42. As shown in the illustrated example, the distance from the tips (apexes) of the guide portions 52 to the normal N may correspond to the second distance R2. As shown in the illustrated example, a circle may be drawn, which has an outerline passing along the tips of all the guide portions 52 and which has the second distance R2 serving as a radius thereof.

The magnetic field generation unit 2 may have at least the partial cylindrical surface 22 that corresponds to a part or all of a cylindrical surface located at a first distance R1 from the rotational axis O. In other words, the magnetic field generation unit 2 may have the cylindrical surface 22 that corresponds to at least a part of a cylindrical surface formed by rotating a busbar L located at the first distance R1 from the rotational axis O. The second distance R2 may be the same as or slightly larger than the first distance R1.

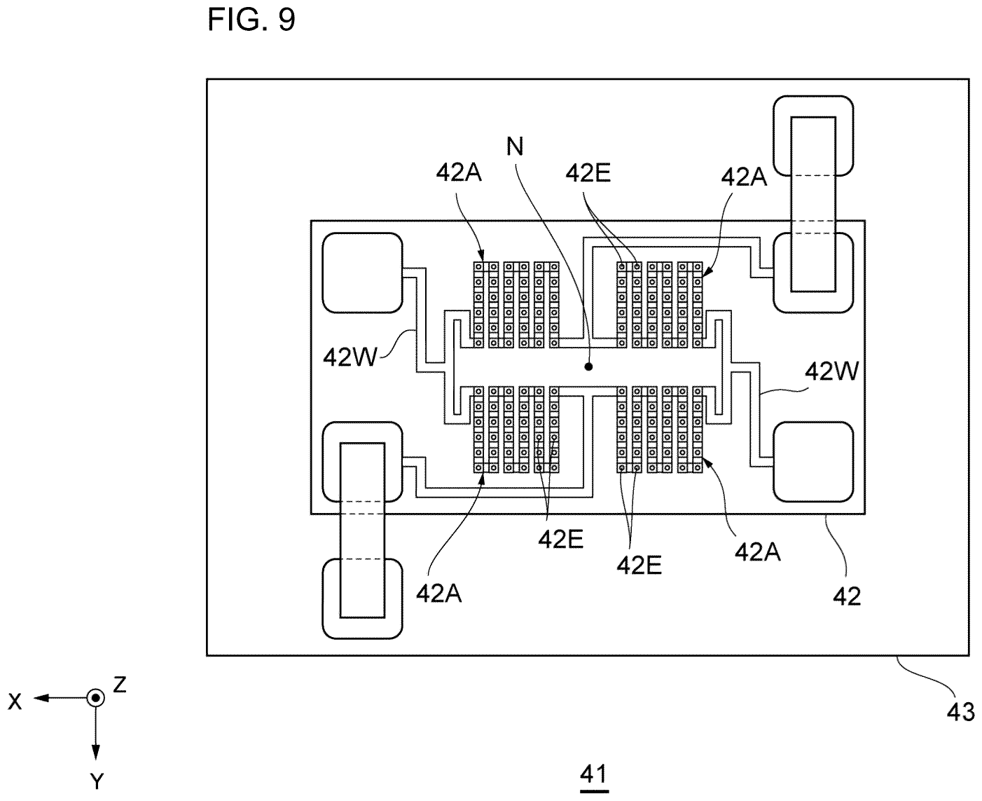

FIG. 9 is a bottom view schematically showing the functional film 42 shown in FIG. 8. As shown in FIG. 9, the functional film 42 may include at least one magnetic detection element 42E that detects the magnetic field H generated by the magnetic field generation unit 2 and generates a detection signal. As shown in the illustrated example, the functional film 42 may include at least one magnetic detection element array 42A, an inorganic film that surrounds the magnetic detection element array 42A, and the like. Each magnetic detection element array 42A may be composed of a plurality of magnetic detection elements 42E that are connected in a chain-like manner and are arrayed in a matrix pattern.

The inorganic film may be either an inorganic film primarily composed of silica (silicon dioxide, SiO₂) or a laminated film composed of an inorganic film primarily composed of silica and an inorganic film primarily composed of alumina (aluminum oxide, Al₂O₃). As shown in the illustrated example, the functional film 42 may include the four magnetic detection element arrays 42A, and the four magnetic detection element arrays 42A may be interconnected by wiring layers 42W.

The detection point of the magnetic sensor chip 41 may align with the center of the functional film 42. When there are two or more magnetic detection element arrays 42A, the magnetic detection element arrays 42A may be arranged to be point-symmetrical with respect to the center of the functional film 42. In other words, the symmetric center of the plurality of magnetic detection element arrays 42A may align with the center of the functional film 42. When there is one magnetic detection element array 42A, the center of the magnetic detection element array 42A may align with the center of the functional film 42. When there is one magnetic detection element 42E, the center of the magnetic detection element 42E may align with the center of the functional film 42.

When each magnetic detection element array 42A is composed of the plurality of magnetic detection elements 42E that are connected in a chain-like manner and are arrayed in a matrix pattern, the plurality of magnetic detection elements 42E may be arrayed along the XY plane. The normal N of the functional film 42 may be orthogonal to the XY plane and may be parallel to a surface-perpendicular direction Z.

An example of the magnetic detection element 42E may be a tunneling magnetoresistance (TMR) effect element. The magnetic detection element 42E is not limited to the TMR element but may also be a giant magnetoresistance effect (GMR) element, an anisotropic magnetoresistance effect (AMR) element, a hall element, or another type of a magnetic detection element. The TMR element is excellent as the magnetic detection element 42E according to the present disclosure because its smaller bonding area compared to other types of MR elements allows for the miniaturization of the magnetic sensor chip 41, and its large MR ratio allows for an increase in the output of the magnetic sensor chip 41.

The rotary sensor device 3 may be configured to detect a first component of the magnetic field H generated by the magnet 21, the first component being oriented in the direction parallel to the X-direction of the magnetic field component applied to the rotary sensor device 3, and to generate a first detection signal indicating the intensity of the first component. In addition, the rotary sensor device 3 may be configured to detect a second component of the magnetic field H generated by the magnet 21, the second component being oriented in the direction parallel to the Y-direction, and to generate a second detection signal indicating the intensity of the second component. By calculating the arctangent of the ratio of the first detection signal to the second detection signal, the processor may be configured to calculate the rotation angle θ of the magnetic field H generated by the magnet 21 with respect to the reference direction. The magnetic sensor chip 41 may include an application-specific integrated circuit (ASIC) 43 that includes a processor or the like.

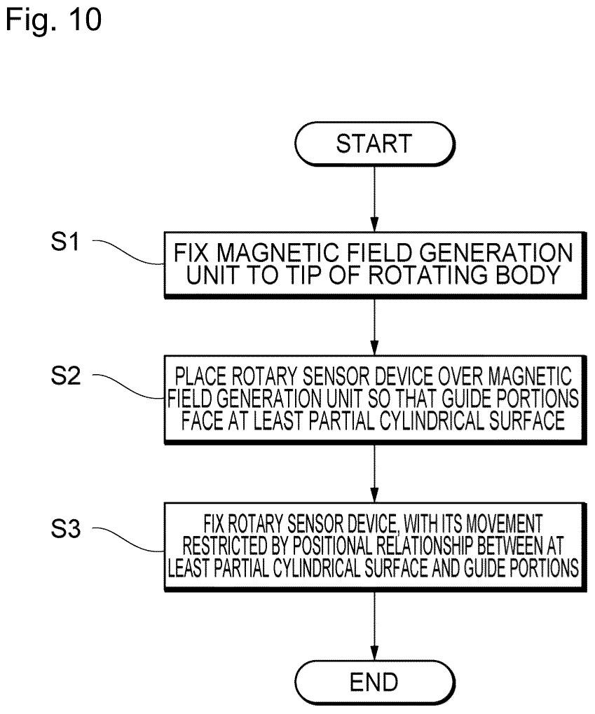

FIG. 10 is a flowchart for describing an installation method for the rotary sensor device. As shown in FIG. 10, in the installation method for the rotary sensor device 3, the magnetic field generation unit 2 may be fixed to the tip of a rotating body, such as the output shaft 120, in step S1. In step S2, the rotary sensor device 3 may be placed over the magnetic field generation unit 2 so that the guide portions 52 face at least the partial cylindrical surface 22. In step S3, the rotary sensor device 3 may be fixed to the housing 110 that rotatably supports the rotating body such as the output shaft 120, with its movement restricted by the positional relationship between at least the partial cylindrical surface 22 and the guide portions 52.

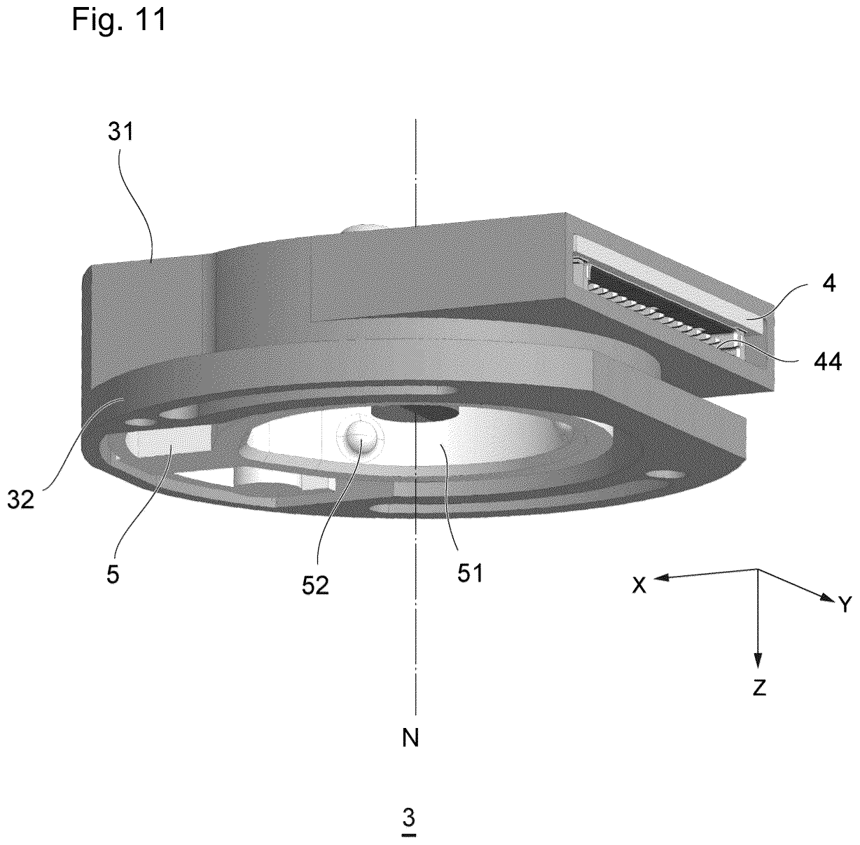

FIG. 11 is a perspective view showing the guide portions 52 according to a first embodiment. As shown in FIG. 11, each of the plurality of guide portions 52 may be formed in a hemispherical shape that protrudes from the inner wall of the cavity 51 toward the normal N.

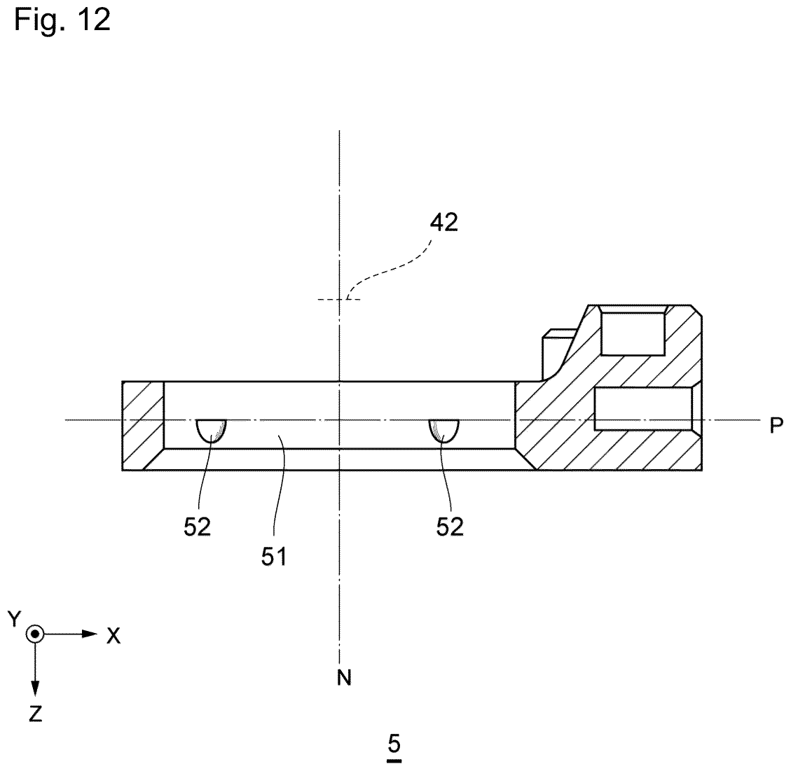

FIG. 12 is a perspective view showing the guide portions 52 according to a second embodiment. As shown in FIG. 12, each of the plurality of guide portions 52 may be flush with the inner wall of the cavity 51 on the side closer to the functional film 42 than an imaginary plane P orthogonal to the normal N, may protrude from the inner wall of the cavity 51 on the side farther from the functional film 42 than the plane P, and may be inclined such that the amount of protrusion from the cavity 51 decreases as the distance from the functional film 42 increases. In the illustrated example, each of the plurality of guide portions 52 is formed in an approximately quarter-spherical shape.

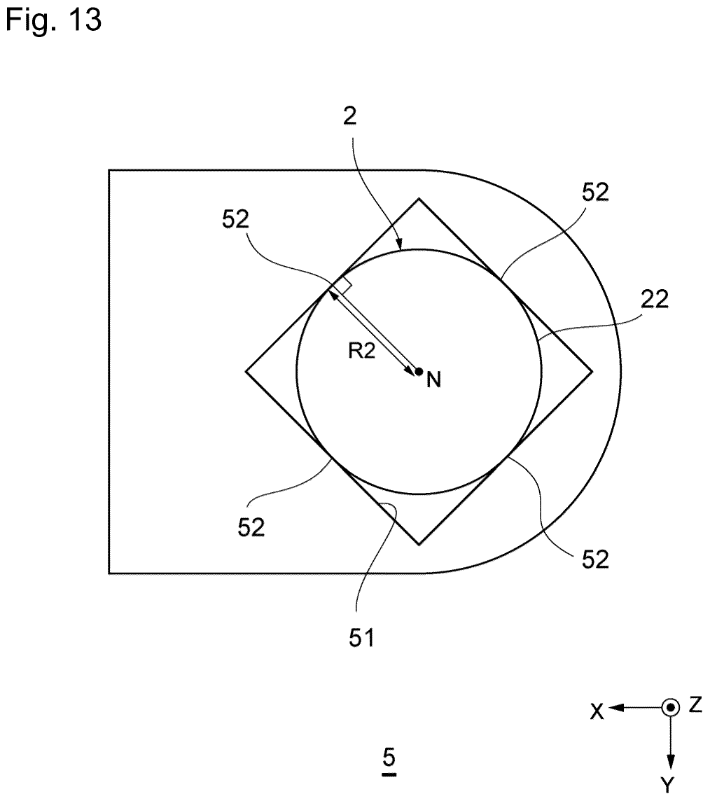

FIG. 13 is a bottom view schematically showing the guide portions 52 according to a third embodiment. As shown in FIG. 13, when viewed along the normal N, at least a part of the contour of the cavity 51 may be a tangent to the circle that represents the contour of the cylindrical surface 22, and the plurality of guide portions 52 may be the points of contact between such tangents and the circle.

As shown in the illustrated example, the cavity 51 may be configured as a polygonal hole that penetrates through the guide member 5 in the surface-perpendicular direction Z parallel to the normal N. Instead of a through hole, an L-shaped notch may be formed in guide member 5 to configure the space between the notch and the housing 31 as a cavity.

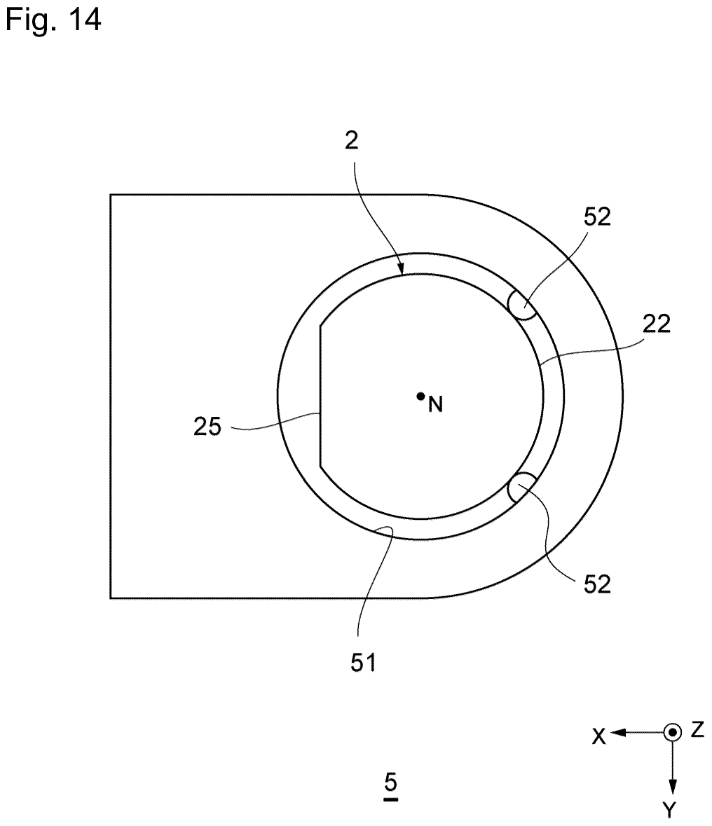

FIG. 14 is a bottom view schematically showing the magnetic field generation unit according to a fourth embodiment. As shown in the illustrated example, the magnetic field generation unit 2 may have a cylindrical surface 22 that is not a 360-degree circumferential surface. In order to more explicitly indicate a part of a 360-degree circumferential cylindrical surface, the “cylindrical surface 22” may be referred to as the “partial cylindrical surface 22.” In the circumferential direction of the cylindrical surface 22, one end and the other end of the cylindrical surface 22 may be connected by a connection surface 25. The connection surface 25 may be a plane, a convex surface with a curvature different from that of the cylindrical surface 22, or a concave surface.

For example, in the shovel or the like of construction machinery, the rotation angle of the bucket or arm may be less than 360 degrees. In order to detect the rotation angle of the bucket or arm, the rotary sensor unit 1 according to the present disclosure may be installed. In this case, the rotary sensor unit 1, which includes the magnetic field generation unit 2 according to the fourth embodiment, may be used.

As shown in the illustrated example, the plurality of guide portions 52 may include the two guide portions 52. When there are two or more guide portions 52, the distance from each of the two guide portions 52 to the normal N is the second distance R2, which is known, and the interval between the two guide portions 52 is also known. Therefore, the position of the normal N may be calculated on the basis of the two guide portions 52. By arranging the guide portions 52 to face the cylindrical surface 22, the normal N may be aligned with the rotational axis O.

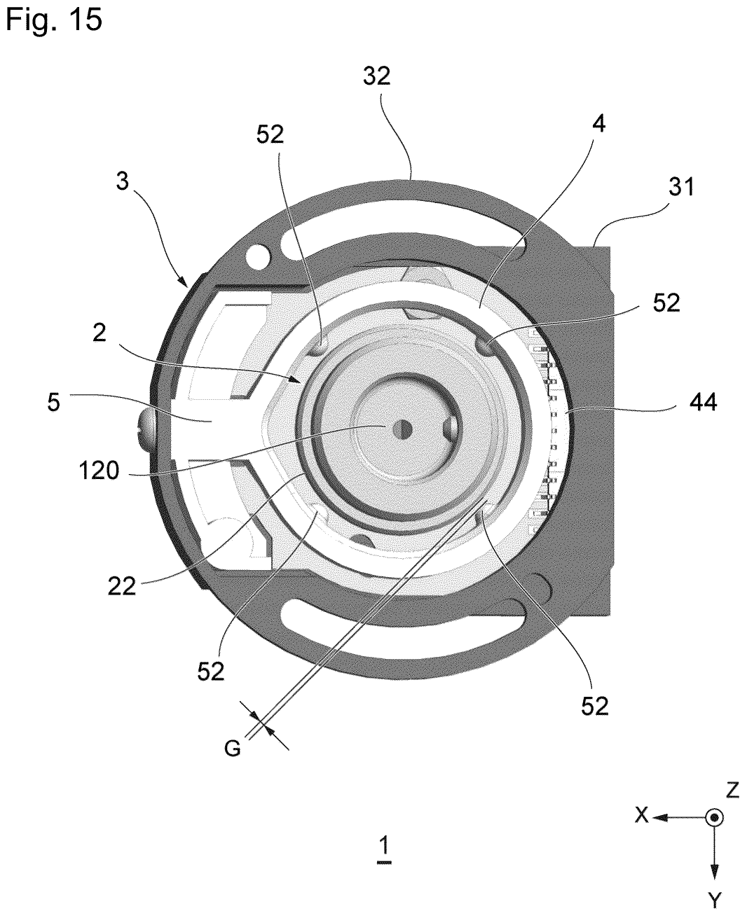

FIG. 15 is a bottom view showing the guide portions 52 according to a fifth embodiment. As shown in FIG. 15, a gap G may be present between each of the plurality of guide portions 52 and the cylindrical surface 22. As shown in the illustrated example, the position of the rotary sensor device 3 may be adjusted so that the gap G between each of the plurality of guide portions 52 and the cylindrical surface 22 falls within the range of 0.1 mm to 0.2 mm, and so that all the gaps G are equal to each other under visual observation.

According to the rotary sensor device 3 of the present disclosure, which is configured as described above, and the related art, the center of the functional film 42 may be aligned with the rotational axis O by the cylindrical surface 22 of the magnetic field generation unit 2 and the plurality of guide portions 52 of the rotary sensor device 3. It is possible to reduce the error caused by the positional shift between the magnetic field generation unit 2 and the magnetic sensor chip 41.

More specifically, a rotary sensor device according to an example embodiment of the present disclosure is a rotary sensor device that detects the rotational state of a magnetic field generation unit that rotates about a rotational axis. The magnetic field generation unit has at least a partial cylindrical surface, which is a part or all of a cylindrical surface that generates a magnetic field symmetrical with respect to the rotational axis and is located at a first distance from the rotational axis. The rotary sensor device includes a functional film containing a magnetic detection element that detects the magnetic field generated by the magnetic field generation unit, and a guide portion provided at a second distance from a normal passing through the center of the functional film. The second distance is the same as or slightly larger than the first distance, and the guide portion is arranged to face at least the partial cylindrical surface.

A rotary sensor unit according to an example embodiment of the present disclosure includes a magnetic field generation unit that rotates about a rotational axis, and a rotary sensor device that detects the rotational state of the magnetic field generation unit. The magnetic field generation unit has at least a partial cylindrical surface, which is a part or all of a cylindrical surface that generates a magnetic field symmetrical with respect to the rotational axis and is located at a first distance from the rotational axis. The rotary sensor device includes a functional film containing a plurality of magnetic detection elements that detect the magnetic field generated by the magnetic field generation unit, and a guide portion provided at a second distance from a normal passing through the center of the functional film. The second distance is the same as or slightly larger than the first distance, and the guide portion is arranged to face the cylindrical surface.

An installation method for a rotary sensor device according to an example embodiment of the present disclosure is an installation method for a rotary sensor device that detects the rotational state of a magnetic field generation unit that rotates about a rotational axis. The magnetic field generation unit has at least a partial cylindrical surface, which is a part or all of a cylindrical surface that generates a magnetic field symmetrical with respect to the rotational axis and is located at a first distance from the rotational axis. The rotary sensor device includes a functional film containing a magnetic detection element that detects the magnetic field generated by the magnetic field generation unit, and a guide portion provided at a second distance from a normal passing through the center of the functional film. The second distance is the same as or slightly larger than the first distance. The method includes: fixing the magnetic field generation unit to the tip of a rotating body; placing the rotary sensor device over the magnetic field generation unit so that the guide portion faces at least the partial cylindrical surface; and fixing the rotary sensor device to a housing that rotatably supports the rotating body, with its movement restricted by the positional relationship between at least the partial cylindrical surface and the guide portion.

According to these embodiments, the center of the functional film may be aligned with the rotational axis by the cylindrical surface of the magnetic field generation unit and the guide portion of the rotary sensor device.

In the above embodiments, at least a part of the guide portion may be in contact with at least the partial cylindrical surface.

According to this embodiment, the rotary sensor device may be accurately aligned with the magnetic field generation unit.

In the above embodiments, the gap between the guide portion and at least the partial cylindrical surface may be 0.2 mm or less.

According to this embodiment, a gap between the magnetic field generation unit and the rotary sensor device is permissible. Therefore, power loss due to frictional resistance may be suppressed.

In the above embodiments, the guide portion may be provided at a plurality of locations. In other words, at least the one guide portion may include a plurality of guide portions.

According to this embodiment, compared to an embodiment in which one guide portion is formed in a ring-shape and faces the cylindrical surface in all directions, the contact area may be decreased. Therefore, power loss due to frictional resistance may be suppressed.

In the above embodiments, the plurality of guide portions may be made of polyacetal resin, polyamide resin, or polybutylene terephthalate resin.

According to this embodiment, the guide portions, which have excellent characteristics such as mechanical strength, wear resistance, and self-lubricity, may be obtained.

In the above embodiments, a cavity that accommodates the magnetic field generation unit may be formed, and each of the plurality of guide portions may be formed in a hemispherical shape that protrudes from the inner wall of the cavity toward the normal.

In the above embodiments, a cavity that accommodates the magnetic field generation unit may be formed, and each of the plurality of guide portions may be flush with the inner wall of the cavity on the side closer to the functional film than a plane orthogonal to the normal, may protrude from the inner wall of the cavity on the side farther from the functional film than the plane, and may be inclined such that the amount of protrusion decreases as the distance from the functional film increases.

According to these embodiments, the contact area between the cylindrical surface and the tips of the guide portions is small. Therefore, power loss due to frictional resistance may be suppressed. The guide portions are inclined such that the amount of their protrusion decreases as the distance from the functional film in the surface-perpendicular direction parallel to the normal increases, facilitating the installation of the rotary sensor device onto the magnetic field generation unit. If the inner wall of the cavity is flush on the side closer to the functional film than the plane orthogonal to the normal, it is less likely for a molded article including the guide portions to get caught when extracting the molded article from the mold, using the plane as the parting surface of the mold.

In the above embodiments, a cavity that accommodates the magnetic field generation unit may be formed. When viewed along the normal, at least a part of the contour of the cavity may be a tangent to the circle that represents the contour of at least a partial cylindrical surface, and the plurality of guide portions may be the points of contact between such tangents and the circle.

According to this embodiment, the guide portions with a shape other than a protrusion may be selected.

In the above embodiments, each of the plurality of guide portions may be provided on a guide member that is an integral structure.

If the plurality of guide portions are provided in a detachable structure, the positional relationship between the plurality of guide portions is likely to shift depending on the assembly accuracy and the accumulation of dimensional tolerances of the plurality of components that constitute the structure. According to this embodiment, each of the plurality of guide portions is provided on the guide member that is an integral structure. Therefore, the positional relationship between the plurality of guide portions is less likely to shift.

In the above embodiments, the magnetic field generation unit may be magnetized in the direction orthogonal to the rotational axis, and may include a magnet that is arranged on the rotational axis.

In the above embodiments, the magnetic field generation unit may include a pair of magnets that is magnetized parallel to the rotational axis and in opposite directions and is arranged symmetrically about the rotational axis.

According to these embodiments, the magnetic field generation unit, which generates a magnetic field symmetrical with respect to the rotational axis, may be obtained.

In the above embodiments, the rotational state may refer to the rotation angle of the magnetic field generation unit.

According to this embodiment, the rotary sensor device may be used as an angular sensor that detects the rotation angle of the magnetic field generation unit.

An electric motor according to an example embodiment of the present disclosure may include the rotary sensor unit according to the above embodiments, and may further include a housing onto which a rotary sensor device is installed and an output shaft to which a magnetic field generation unit is attached.

A rotating mechanism according to an example embodiment of the present disclosure may include the electric motor according to the above embodiments. The rotating mechanism may be an autonomous mobile robot, a battery electric vehicle, a hybrid electric vehicle, an elevator, or an actuator.

These embodiments allow the rotary sensor device to be applied to various purposes.

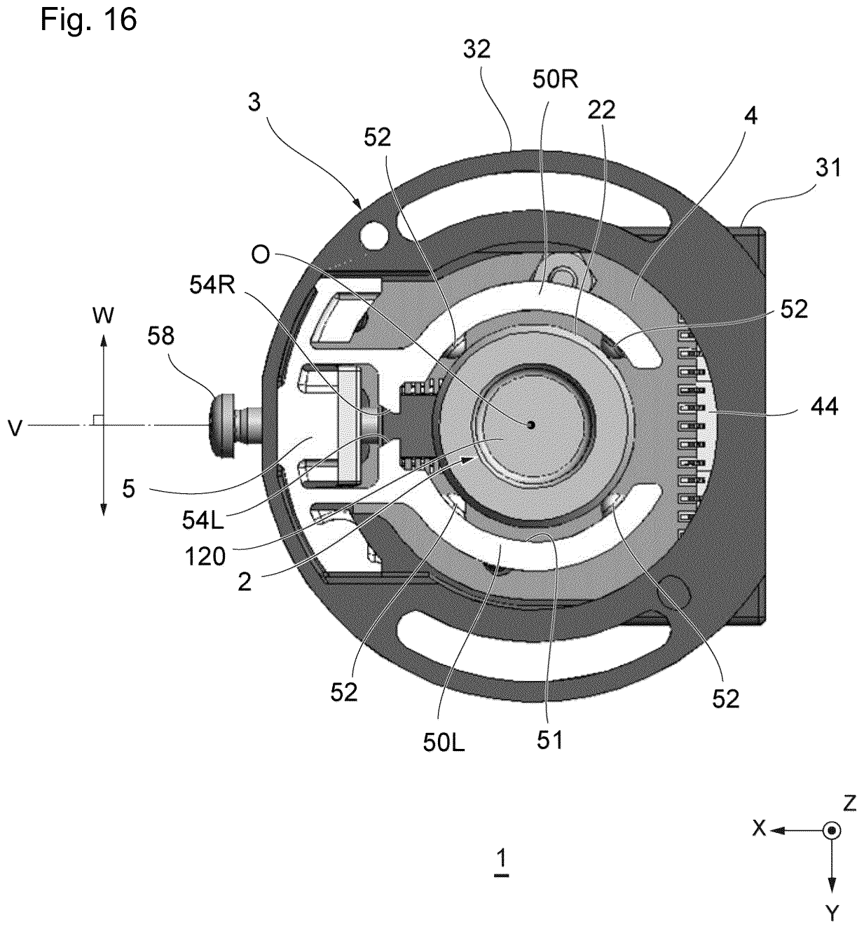

Next, sixth to ninth embodiments will be described with reference to FIGS. 16 to 24. Note that configurations with functions same as or similar to those of the first embodiment will be denoted by the same reference numerals, and corresponding descriptions in the first embodiment will be referred to. The descriptions of the configurations will be omitted here. Furthermore, configurations other than those described below are the same as those of the first embodiment.

FIG. 16 is a bottom view showing a first shape of the guide member 5 according to the sixth embodiment. As shown in FIG. 16, the rotary sensor device 3 may include the substrate 4, the guide member 5, and the like that are accommodated in the housing 31. As shown in the illustrated example, the guide member 5 may include a pair of a first arm 50L and a second arm 50R, a press member 58 that presses the first arm 50L and the second arm 50R, and the like. The cavity 51 that accommodates the magnetic field generation unit 2 may be formed in a space surrounded by the first arm 50L and the second arm 50R.

The guide member 5 may include the plurality of guide portions 52 provided on the first arm 50L and the second arm 50R. When there are two or more guide portions 52, the distance from each of the two guide portions 52 to the normal N is the second distance R2, which is known, and the interval between the two guide portions 52 is also known. Therefore, the position of the normal N may be calculated on the basis of the two guide portions 52. By arranging the guide portions 52 to face the cylindrical surface 22, the normal N may be aligned with the rotational axis O. The number of the guide portions 52 may be three or more. As shown in the illustrated example, a total of the four guide portions 52, two on each of the first arm 50L and the second arm 50R, may be formed.

Like the material for the guide member 5 in the first embodiment described above, the material for the first arm 50L and the second arm 50R including the plurality of guide portions 52 may be engineering plastic, such as polyacetal resin, polyamide resin, or polybutylene terephthalate resin, which has excellent mechanical strength and allows for elastic deformation. Each of the plurality of guide portions 52 may be arranged to face the cylindrical surface 22 of the magnetic field generation unit 2.

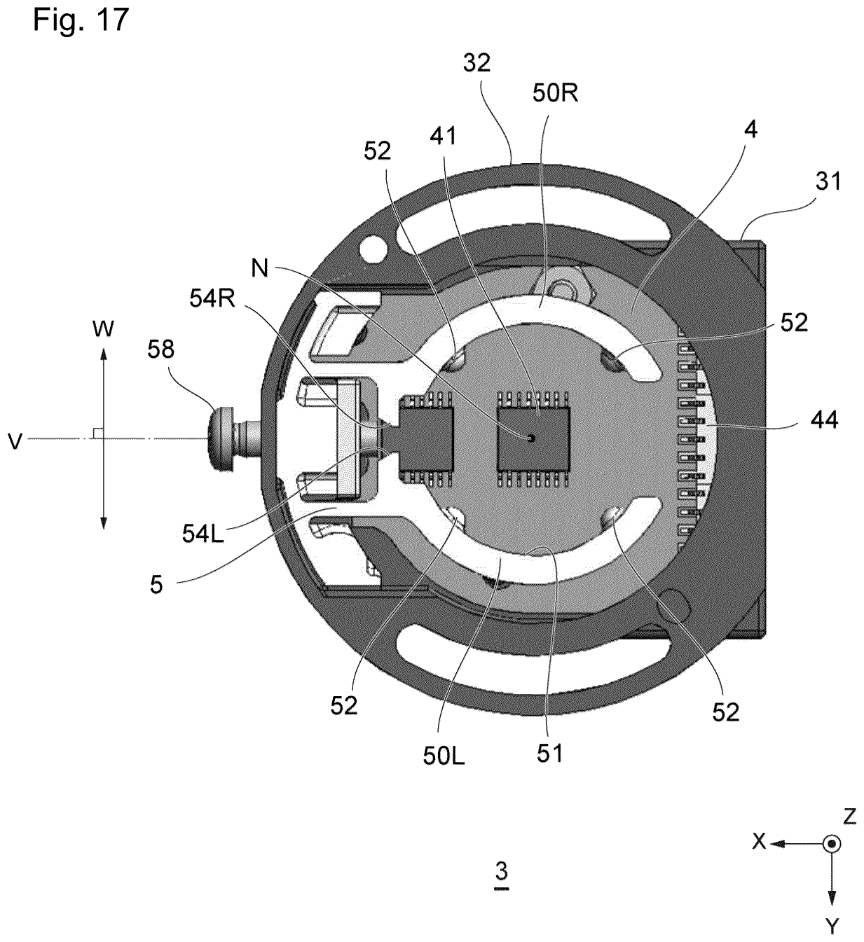

FIG. 17 is a bottom view showing the rotary sensor device 3 shown in FIG. 16. Like the first embodiment described above, the magnetic sensor chip 41 that detects the rotational state, such as the rotation angle θ, of the magnetic field generation unit 2, the connector 44 that is connected to a power supply or external equipment, and the like may be mounted on the substrate 4. The substrate 4 may be either a rigid substrate or a flexible substrate.

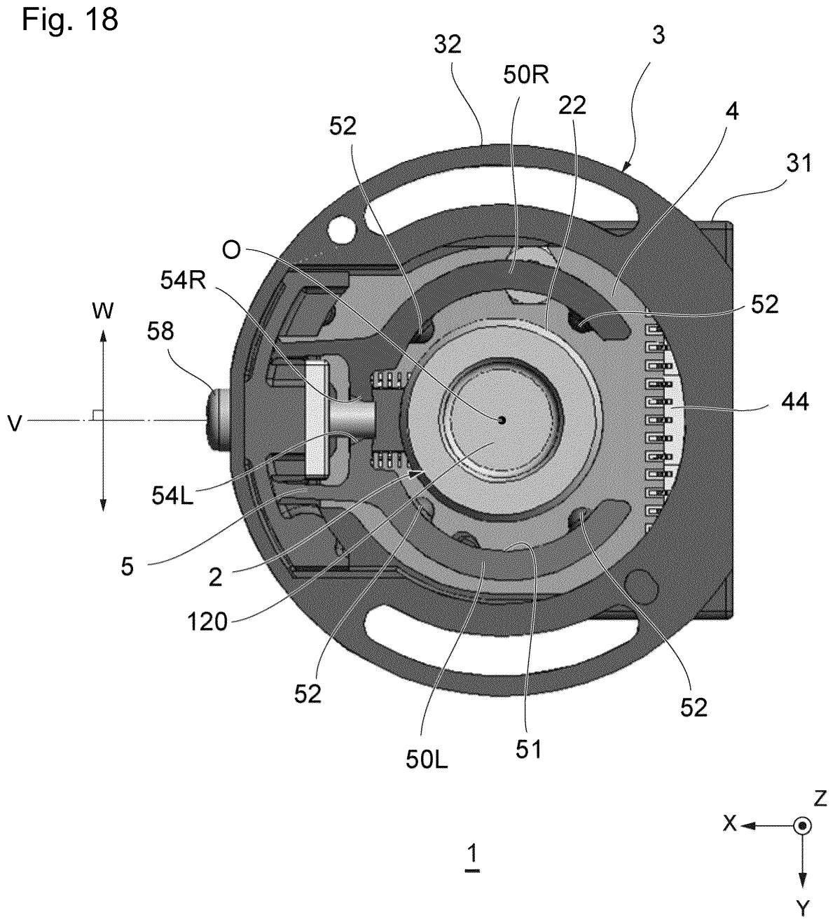

FIG. 18 is a bottom view showing a second shape of the guide member 5 according to the sixth embodiment. Hereinafter, the deformation of the guide member 5 will be described in comparison to the first shape shown in FIG. 16. The guide member 5 may be configured to be deformable into the first shape that is in contact with the cylindrical surface 22 and the second shape that is separated from the cylindrical surface 22.

As shown in the illustrated example, when the pair of the first arm 50L and the second arm 50R is elastically deformable and the press member 58 presses the first arm 50L and the second arm 50R against an urging force, the guide member 5 may deform from the first shape shown in FIG. 16 to the second shape shown in FIG. 18. Conversely, when the press member 58 is separated from the first arm 50L and the second arm 50R, the guide member 5 may deform from the second shape to the first shape due to the restoration force of the first arm 50L and the second arm 50R.

More specifically, the press member 58 may move along a first axis V orthogonal to the rotational axis O. The direction orthogonal to the first axis V and parallel to the XY plane may be referred to as a second direction Was appropriate. The first arm 50L may have a first inclined surface 54L that faces the press member 58, and the second arm 50R may have a second inclined surface 54R that faces the press member 58.

When the guide member 5 assumes the first shape shown in FIG. 16, the first inclined surface 54L and the second inclined surface 54R may be inclined in such a way that, as they approach the rotational axis O, the surfaces approach the first axis V in the second direction W. When brought closer to the rotational axis O, the press member 58 presses the first inclined surface 54L and the second inclined surface 54R against an urging force. As a result, the first arm 50L and the second arm 50R are separated from the cylindrical surface 22, and the guide member 5 may assume the second shape shown in FIG. 18.

The press member 58 is, for example, a bolt. When a screw is tightened, the press member 58 may press the first inclined surface 54L and the second inclined surface 54R. When the screw is loosened, the press member 58 may separate from the first inclined surface 54L and the second inclined surface 54R. In order to evenly press the first inclined surface 54L and the second inclined surface 54R, the tip of the press member 58 may be tapered.

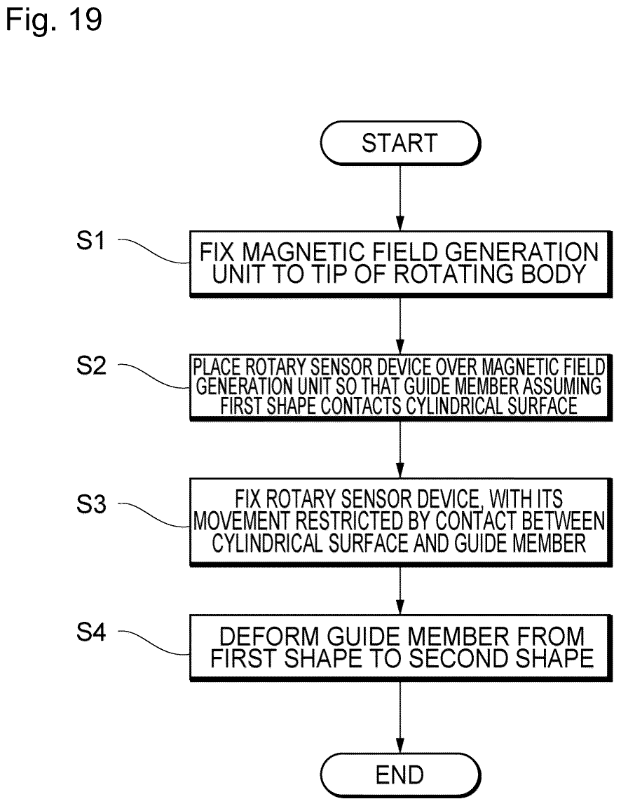

FIG. 19 is a flowchart for describing an installation method for the rotary sensor device. As shown in FIG. 19, in the installation method for the rotary sensor device 3, the magnetic field generation unit 2 may be fixed to the tip of a rotating body, such as the output shaft 120, in step S1. In step S2, the rotary sensor device 3 may be placed over the magnetic field generation unit 2 so that the guide member 5 assuming the first shape contacts the cylindrical surface 22. In step S3, the rotary sensor device 3 may be fixed to the housing 110 that rotatably supports the rotating body such as the output shaft 120, with its movement restricted by the contact between the cylindrical surface 22 and the guide member 5. In step S4, the guide member 5 may deform from the first shape to the second shape. Therefore, by separating the guide member 5 from the cylindrical surface 22, power loss due to frictional resistance may be suppressed.

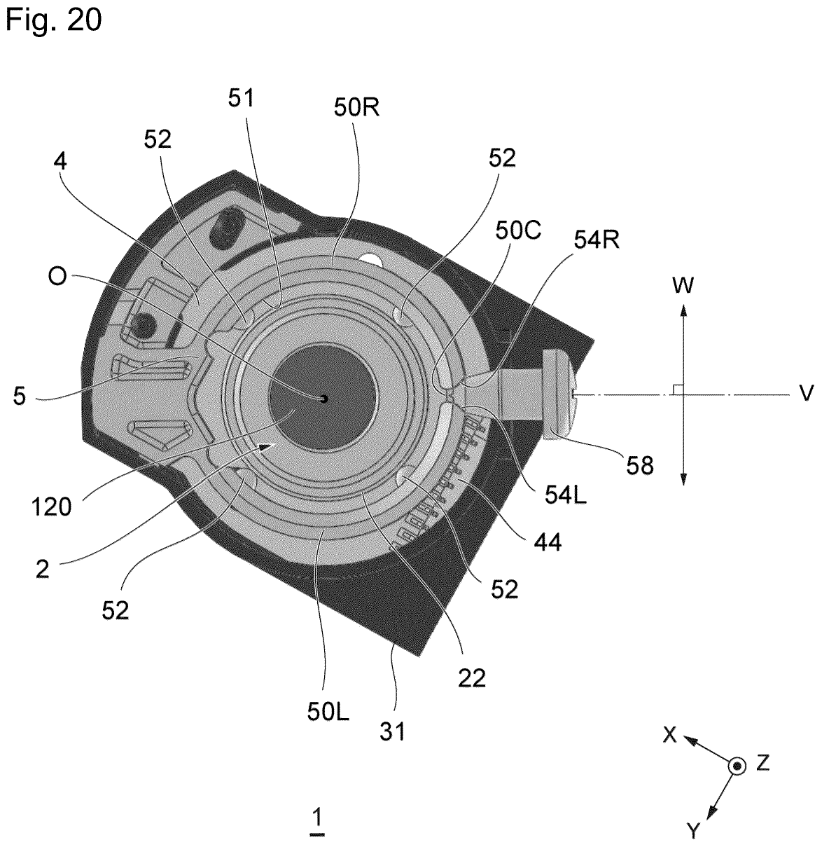

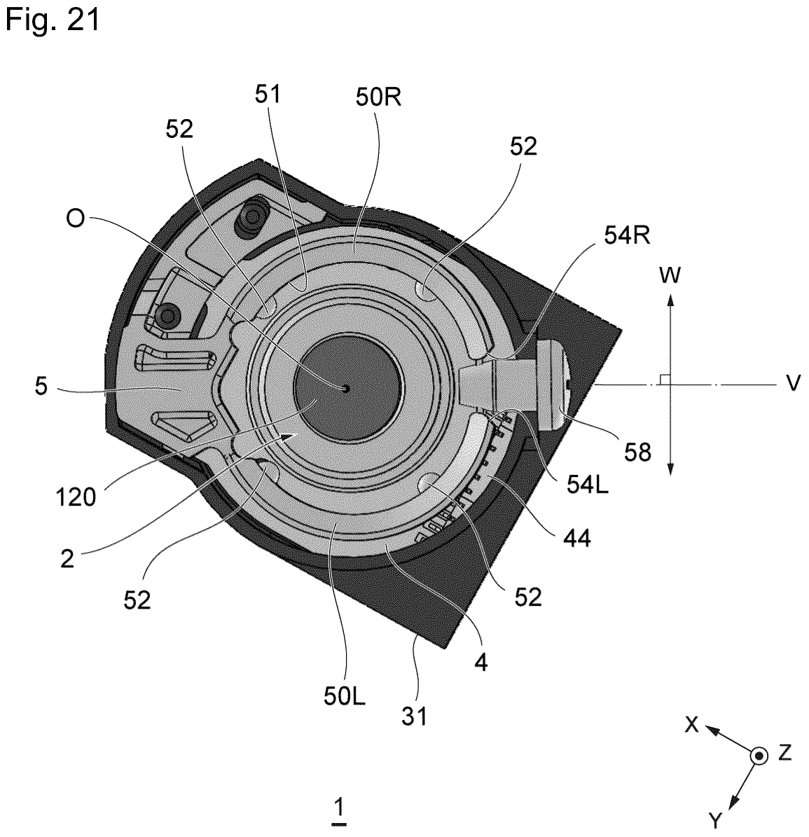

FIGS. 20 and 21 are bottom views showing the first shape and the second shape of the guide member 5 according to the seventh embodiment, respectively. The guide member 5 according to the seventh embodiment may further include a connection member that connects the first arm 50L and the second arm 50R when assuming the first shape. When the guide member 5 deforms from the first shape shown in FIG. 20 to the second shape shown in FIG. 21, the press member 58 may cut off a connection portion 50C.

In the illustrated example, the first arm 50L may have the first inclined surface 54L, and the second arm 50R may have the second inclined surface 54R. When the guide member 5 assumes the first shape shown in FIG. 20, the first inclined surface 54L and the second inclined surface 54R may be inclined in such a way that, as they approach the rotational axis O, the surfaces approach the first axis V in the second direction W. When brought closer to the rotational axis O, the press member 58 may press the first inclined surface 54L and the second inclined surface 54R against an urging force. As a result, the first arm 50L and the second arm 50R are separated from the cylindrical surface 22, and the guide member 5 may assume the second shape shown in FIG. 21.

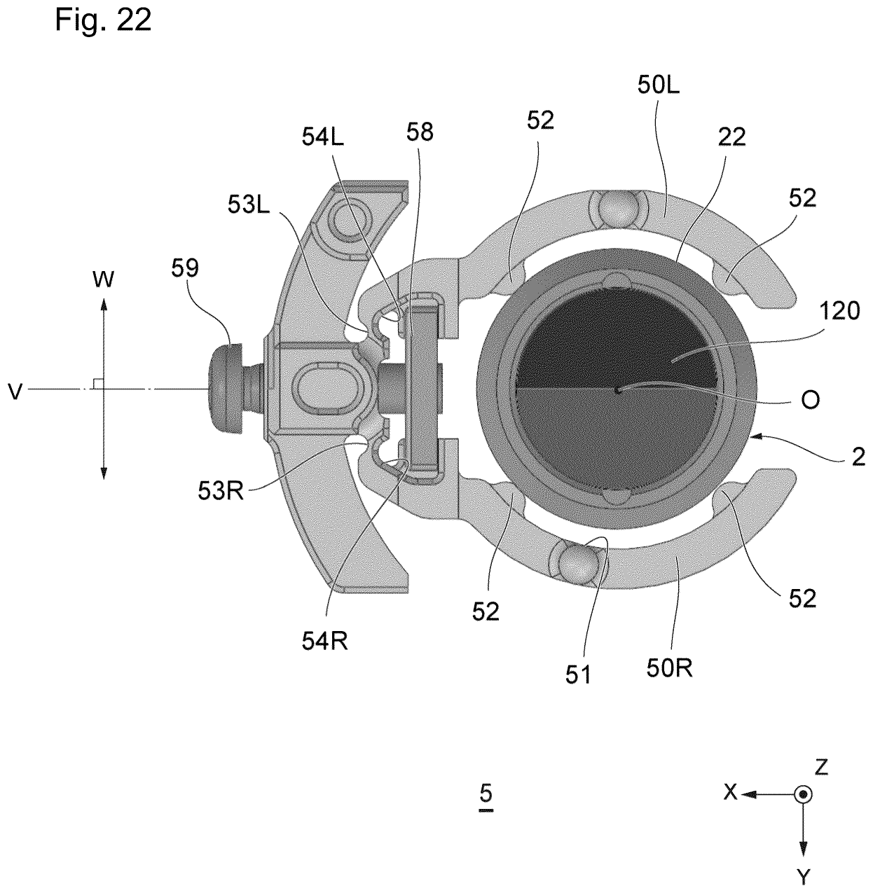

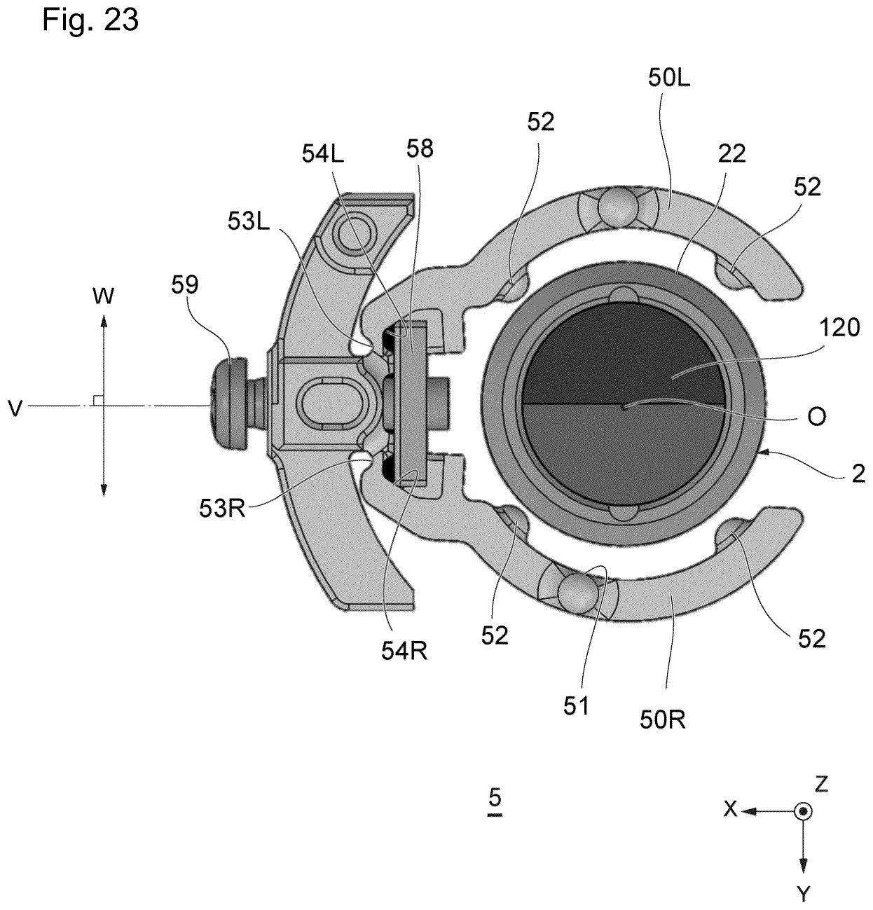

FIGS. 22 and 23 are bottom views showing the first shape and the second shape of the guide member 5 according to the eighth embodiment, respectively. The guide member 5 according to the eighth embodiment may include a linear-motion mechanism that converts rotational motion into the linear motion of the press member 58. As shown in the illustrated example, the linear-motion mechanism may be a combination of the press member 58, which functions as a nut, and a screw shaft 59. The linear-motion mechanism is not particularly limited and may be a ball screw, a rack-and-pinion, or another type.

The first arm 50L may have the first inclined surface 54L that faces the press member 58, or it may be elastically deformable and rotate about a first hinge 53L. The second arm 50R may have the second inclined surface 54R that faces the press member 58, or it may be elastically deformable and rotate about a second hinge 53R. As shown in the illustrated example, the first hinge 53L and the second hinge 53R may be resin hinges that are formed to be thinner than other portions and foldable.

As shown in the illustrated example, the first axis V orthogonal to the rotational axis O may align with the center of the screw shaft 59. When the guide member 5 assumes the first shape shown in FIG. 16, the first inclined surface 54L and the second inclined surface 54R may be inclined in such a way that, as they approach the rotational axis O, the surfaces are farther from the first axis V in the second direction W.

When the guide member 5 assumes the first shape shown in FIG. 22, the press member 58 may press the first inclined surface 54L and the second inclined surface 54R as it is moved away from the rotational axis O. Thus, the first arm 50L and the second arm 50R are separated from the cylindrical surface 22, and the guide member 5 may deform into the second shape shown in FIG. 23. When the guide member 5 assumes the second shape shown in FIG. 23, the first arm 50L and the second arm 50R may deform to sandwich the cylindrical surface 22 due to their restoration force and return to the first shape as the press member 58 is moved closer to the rotational axis O. Because the guide member 5 is capable of returning to the first shape, the rotary sensor device 3 may be removed to be reusable.

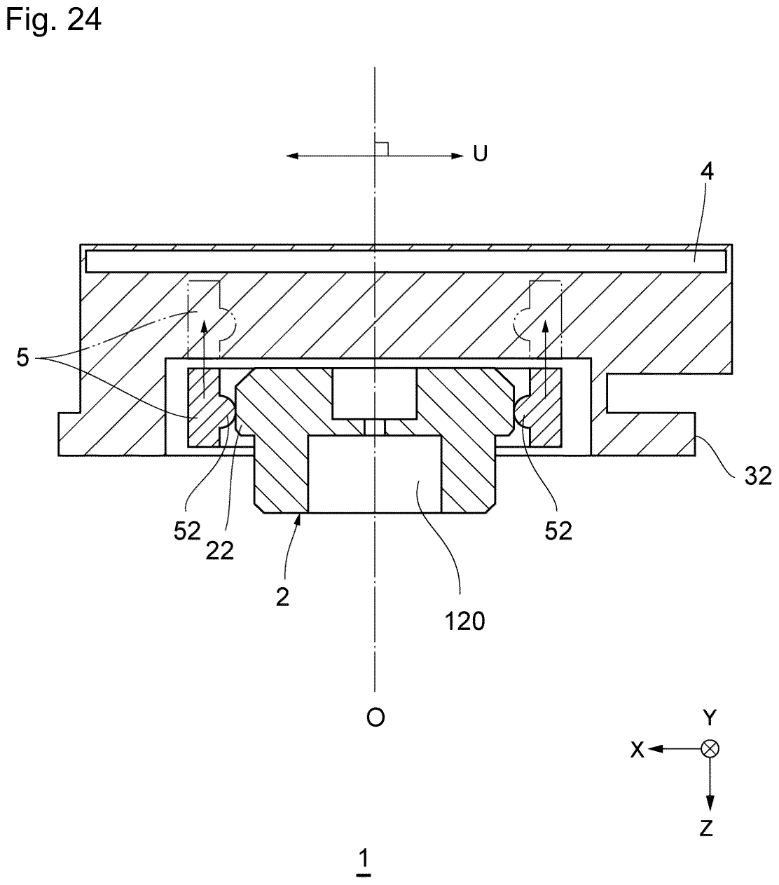

FIG. 24 is a side view showing the first shape of the guide member 5 according to the ninth embodiment. As shown in the illustrated example, the guide member 5 may move in the surface-perpendicular direction Z. The guide member 5 assuming the first shape may be arranged so as to overlap the cylindrical surface 22 in a radial direction U orthogonal to the rotational axis O. The guide member 5 assuming the second shape may move toward the substrate 4 and be arranged so as not to overlap the cylindrical surface 22 in the radial direction U.

A rotary sensor device according to an example embodiment of the present disclosure is a rotary sensor device that detects the rotational state of a magnetic field generation unit that rotates about a rotational axis. The magnetic field generation unit has a cylindrical surface that generates a magnetic field symmetrical with respect to the rotational axis and is centered about the rotational axis. The rotary sensor device includes a magnetic detection element that detects the magnetic field generated by the magnetic field generation unit and a guide member that is deformable into a first shape in contact with the cylindrical surface and a second shape separated from the cylindrical surface.

A rotary sensor unit according to an example embodiment of the present disclosure includes a magnetic field generation unit that rotates about a rotational axis and a rotary sensor device that detects the rotational state of the magnetic field generation unit. The magnetic field generation unit has a cylindrical surface that generates a magnetic field symmetrical with respect to the rotational axis and is centered about the rotational axis. The rotary sensor device includes a magnetic detection element that detects the magnetic field generated by the magnetic field generation unit and a guide member that is deformable into a first shape in contact with the cylindrical surface and a second shape separated from the cylindrical surface.

An installation method for a rotary sensor device according to an example embodiment of the present disclosure is an installation method for a rotary sensor device that detects the rotational state of a magnetic field generation unit that rotates about a rotational axis. The magnetic field generation unit has a cylindrical surface that generates a magnetic field symmetrical with respect to the rotational axis and is centered about the rotational axis. The rotary sensor device includes a magnetic detection element that detects the magnetic field generated by the magnetic field generation unit and a guide member that is deformable into a first shape in contact with the cylindrical surface and a second shape separated from the cylindrical surface. The method includes: fixing the magnetic field generation unit to the tip of a rotating body; placing the rotary sensor device over the magnetic field generation unit so that the guide member assuming the first shape contacts the cylindrical surface; fixing the rotary sensor device to a housing that rotatably supports the rotating body, with its movement restricted by the contact between the cylindrical surface and the guide member; and deforming the guide member from the first shape to the second shape.

According to these embodiments, the center of a detection unit including the magnetic detection element may be aligned with the rotational axis by the cylindrical surface of the magnetic field generation unit and the guide member of the rotary sensor device. It is possible to reduce the error caused by the positional shift between the magnetic field generation unit and a magnetic sensor chip. By separating the guide member from the cylindrical surface, power loss due to frictional resistance may be suppressed.

In the above embodiments, the guide member may include a first arm and a second arm that are elastically deformable and a press member that presses the first arm and the second arm. When the press member presses the first arm and the second arm against an urging force, the guide member may deform either from a first shape to a second shape or from the second shape to the first shape. When the press member is separated from the first arm and the second arm, the guide member may deform either from the second shape to the first shape or from the first shape to the second shape due to the restoration force of the first arm and the second arm.

According to this embodiment, the guide member is deformed through the elastic deformation of the first arm and the second arm without using a complicated mechanism. The guide member that is deformable using a small number of components may be configured.

In the above embodiments, the guide member may further include a connection member that connects the first arm and the second arm when assuming the first shape. When the guide member deforms from the first shape to the second shape, the press member may cut off the connection member.

According to this embodiment, the dimensional accuracy of the guide member is improved by the connection portion. Therefore, the rotary sensor device may be accurately aligned with the magnetic field generation unit.

In the above embodiments, the guide member may include a press member that moves along a first axis orthogonal to the rotational axis, a first arm that has a first inclined surface facing the press member and is elastically deformable, and a second arm that has a second inclined surface facing the press member and is elastically deformable. When the guide member assumes the first shape, the first inclined surface and the second inclined surface may be inclined in such a way that, as they approach the rotational axis, the surfaces approach the first axis. When brought closer to the rotational axis, the press member presses the first inclined surface and the second inclined surface against an urging force. As a result, the first arm and the second arm are separated from the cylindrical surface, and the guide member may deform into the second shape.

In the above embodiments, the guide member may include the press member that moves along the first axis orthogonal to the rotational axis, the first arm that has the first inclined surface facing the press member and is elastically deformable, and the second arm that has the second inclined surface facing the press member and is elastically deformable. When the guide member assumes the first shape, the first inclined surface and the second inclined surface may be inclined in such a way that, as they approach the rotational axis, the surfaces are farther from the first axis. When moved away from the rotational axis, the press member presses the first inclined surface and the second inclined surface against an urging force. As a result, the first arm and the second arm are separated from the cylindrical surface, and the guide member may deform into the second shape.

According to these embodiments, the guide member is deformed into the second shape through the first inclined surface, the second inclined surface, and the press member without using a complicated mechanism. The guide member that is deformable using a small number of components may be configured.

In the above embodiments, the guide member may further include a linear-motion mechanism that converts rotational motion into the linear motion of the press member.

According to this embodiment, it is possible to press the first inclined surface and the second inclined surface with the press member without using a complicated mechanism. The linear-motion mechanism is not particularly limited and may be a ball screw, a rack-and-pinion, or another type.

The embodiments described above are provided to facilitate the understanding of the present disclosure and are not intended to limit its interpretation. The respective elements included in the embodiments, as well as their arrangements, materials, conditions, shapes, sizes, and the like, are not limited to the examples shown and may be modified as appropriate. Furthermore, the configurations shown in different embodiments may be partially substituted or combined. For example, the guide portions may be provided on the cylindrical surface 22 of the magnetic field generation unit 2 rather than being provided on the guide member 5.

As opposed to the sixth and seventh embodiments, the first arm 50L and the second arm 50R may be deformed from the second shape to the first shape against an urging force, and may be deformed from the first shape to the second shape due to their restoration force. The first arm 50L and the second arm 50R are not limited to elastically deformable ones. For example, the first arm 50L may be configured to rotate freely about the first hinge 53L without relying on elastic deformation, and a stopper may be provided to stop the rotation of the first arm 50L at the positions where the guide member 5 assumes the first shape and the second shape. The second arm 50R may be configured in the same way as the first arm 50L.

1. A rotary sensor device that detects a rotational state of a magnetic field generation unit that rotates about a rotational axis, wherein
the magnetic field generation unit has at least a partial cylindrical surface, which is a part or all of a cylindrical surface that generates a magnetic field symmetrical with respect to the rotational axis and is located at a first distance from the rotational axis,
the rotary sensor device includes
a functional film containing a magnetic detection element that detects the magnetic field generated by the magnetic field generation unit, and
a guide portion provided at a second distance from a normal passing through a center of the functional film,
the second distance is same as or slightly larger than the first distance, and
the guide portion is arranged to face at least the partial cylindrical surface.

2. The rotary sensor device according to claim 1, wherein
at least a part of the guide portion is in contact with the cylindrical surface.

3. The rotary sensor device according to claim 1, wherein
a gap between the guide portion and the cylindrical surface is 0.2 mm or less.

4. The rotary sensor device according to claim 1, wherein
the guide portion is provided at a plurality of locations.

5. The rotary sensor device according to claim 1, wherein
the guide portion is made of polyacetal resin, polyamide resin, or polybutylene terephthalate resin.

6. The rotary sensor device according to claim 4, wherein
a cavity that accommodates the magnetic field generation unit is formed, and
each of the plurality of guide portions is formed in a hemispherical shape that protrudes from an inner wall of the cavity toward the normal.

7. The rotary sensor device according to claim 1, wherein
a cavity that accommodates the magnetic field generation unit is formed, and
the guide portion is flush with an inner wall of the cavity on a side closer to the functional film than a plane orthogonal to the normal, protrudes from the inner wall of the cavity on a side farther from the functional film than the plane, and is inclined such that an amount of protrusion decreases as a distance from the functional film increases.

8. The rotary sensor device according to claim 4, wherein
a cavity that accommodates the magnetic field generation unit is formed,
at least a part of a contour of the cavity is a tangent to a circle that represents a contour of the cylindrical surface when viewed along the normal, and
the plurality of guide portions are points of contact between the tangents and the circle.

9. The rotary sensor device according to claim 4, wherein
each of the plurality of guide portions is provided on a guide member that is an integral structure.

10. The rotary sensor device according to claim 1, wherein
the magnetic field generation unit is magnetized in a direction orthogonal to the rotational axis, and
includes a magnet that is arranged on the rotational axis.

11. The rotary sensor device according to claim 1, wherein
the magnetic field generation unit includes a pair of magnets that is magnetized parallel to the rotational axis and in opposite directions and is arranged symmetrically about the rotational axis.

12. The rotary sensor device according to claim 1, wherein
the rotational state refers to a rotation angle of the magnetic field generation unit.

13. A rotary sensor unit comprising:
a magnetic field generation unit that rotates about a rotational axis, and
a rotary sensor device that detects a rotational state of the magnetic field generation unit, wherein
the magnetic field generation unit has at least a partial cylindrical surface, which is a part or all of a cylindrical surface that generates a magnetic field symmetrical with respect to the rotational axis and is located at a first distance from the rotational axis,
the rotary sensor device includes
a functional film containing a magnetic detection element that detects the magnetic field generated by the magnetic field generation unit, and
a plurality of guide portions provided at a second distance from a normal passing through a center of the functional film,
the second distance is same as or slightly larger than the first distance, and
the guide portion is arranged to face the cylindrical surface.

14. An electric motor comprising:
the rotary sensor unit according to claim 13;
a housing onto which the rotary sensor device is installed; and
an output shaft to which the magnetic field generation unit is attached.

15. A rotating mechanism comprising:
the electric motor according to claim 14.

16. An installation method for a rotary sensor device that detects a rotational state of a magnetic field generation unit that rotates about a rotational axis, wherein
the magnetic field generation unit has at least a partial cylindrical surface that generates a magnetic field symmetrical with respect to the rotational axis and is located at a first distance from the rotational axis,
the rotary sensor device includes
a functional film containing a plurality of magnetic detection elements that detect the magnetic field generated by the magnetic field generation unit, and
a plurality of guide portions provided at a second distance from a normal passing through a center of the functional film, and
the second distance is same as or slightly larger than the first distance,
the method comprising:
fixing the magnetic field generation unit to a tip of a rotating body;
placing the rotary sensor device over the magnetic field generation unit so that the guide portions face at least the partial cylindrical surface; and
fixing the rotary sensor device to a housing that rotatably supports the rotating body, with movement thereof restricted by a positional relationship between the cylindrical surface and the guide portions.
